(19) United States
(12) Patent Application Publication
(10) Pub. No.: US 2020/0277235 A1
(43) Pub. Date: Sep. 3, 2020

(54) Method for Producing a Molded Product by Sintering

(71) Applicant: Vita Zahnfabrik H. Rauter GmbH & Co. KG, Bad Säckingen (DE)

(72) Inventors: Michael Dorn, Bad Säckingen (DE); Andreas Oberländer, Lörrach (DE); Christian Strasser, Oberkirch (DE)

(21) Appl. No.: 16/647,120

(22) PCT Filed: Sep. 17, 2018
(86) PCT No.: PCT/EP2018/075056

§ 371 Date: Mar. 13, 2020

(30) Foreign Application Priority Data
Sep. 15, 2017 (EP) 17191271.0

(51) Int. Cl. C04B 35/64; C04B 35/16; C04B 35/111; C04B 35/486; C04B 35/565; C04B 35/587; A61C 13/00

(52) U.S. Cl. CPC C04B 35/64; C04B 35/16; C04B 35/111; C04B 35/486; C04B 2235/9638; C04B 35/587; A61C 13/0022; C04B 2235/612; C04B 2235/608; C04B 35/565

(57) ABSTRACT

The present invention relates to a method for producing a molded product from a blank, taking into account the sintering behavior thereof, and to a molded product produced by said method.

The present invention relates to a process for producing a shaped product from a blank in consideration of its sintering behavior, and to a shaped product prepared by the presented process.

Within the scope of the technological progress of the recent years, the demands set on technical components have become more and more complex. This trend relates not only to the field of highly specialized components, for example, in the field of energy generation or automobile industry, but also extends to fields of everyday life, such as medical and cosmetic applications. In order to meet these constantly increasing challenges, the trend is increasingly moving toward the multifunctionalization of components. In particular, the different properties of different materials as well as the advantages obtained from the combination of different materials should take effect in particular fields of application.

The great challenge associated with the production of multifunctional components resides in the fact that the different materials within one component are exposed to the same process parameters during production, and accordingly, the individual reaction of the individual materials during production must be considered. While it was usual to assembly the individual materials in complicated joining methods in the past, it is expected today that the components are prepared in processes as simple as possible, which are to include as few process steps as possible.

The associated difficulties are even higher in those cases where the materials employed require the components to be sintered. This is required, in particular, with metallic and ceramic materials, in order to provide the component or workpiece with the necessary strength and hardness that are necessary in the respective use. Since the starting material is compacted in this method and the pore volumes are reduced or eliminated, shrinking of the workpiece usually occurs, which is to be considered during its preparation in order to reach the final shape expected after sintering. In a workpiece that comprises only one material with a homogeneous sintering behavior, this is no difficulty and can be compensated, for example, by a corresponding addition of material. However, if the workpiece is composed of different materials that show respectively different sintering behaviors, i.e., the shrinkage is not homogeneous, then a simple addition of material is usually not sufficient for the workpiece to obtain the desired geometry.

In the prior art, different methods are known that deal with this problem of distortion due to sintering.

DE 10 2006 024 489 describes a green body which consists of at least two different powder mixtures that are compacted to form a shaped product, wherein the distortion due to sintering is avoided by selecting powder mixtures that have similar volume changes during sintering.

DE 10 2008 013 471 describes ceramic components whose sintering shrinkage is adjusted by using particles with different primary particle sizes.

WO 2013/156483 relates to a process for producing a porous ceramic article having at least two layers, in which the individual layers have different presintering temperatures, which are adjusted through a suitable selection of particle size. The sintering of the article is then performed in consideration of the respectively adjusted presintering temperature.

WO 2015/011079 discloses a process for the manufacture of a multi-layer oxide ceramic body that can be sintered without distortion. The sintering behavior of the individual layers is adjusted by doping the ceramic with sintering aids, especially aluminum oxide for promoting the sintering and yttrium oxide for sintering inhibition.

US 2011/0115210 describes a method for processing a blank, in which the blank can be densely sintered with shrinkage following machining, and machining of the blank is carried out in a machining device allowing for an individual scale-up factor relevant to the blank for compensating for the shrinkage occurring during dense sintering, in which a linear measurement of the blank is performed in one or more of the dimensions length, width, and height for determining the scale-up factor (F), wherein the measured linear measure bears a known relationship to the scale-up factor (F), and the type of blank is known. Linear measurement of the blank can be carried out in the machining device.

US 2006/0131770 describes a process for the production of a dental model, comprising the following steps: (a) provision of one or more fluid, solidifiable materials and one or more electrically conductive substances; (b) production of the dental model by rapid prototyping using the fluid, solidifiable material or materials and the one or more electrically conductive substances, so that the dental model produced is electrically conductive in one or more areas of its surface. Before the model is prepared, geometric data of the dental model can be produced and changed to result in an oversized model that compensates the dimensional changes to be expected during the production process.

US 2011/00639301 discloses a process for sintering an object, comprising the steps of placing an object into a high temperature furnace; heating the furnace; generating a geometric surface profile at least of a subregion of the object by: irradiating the object with light from a light source, and detecting the light scattered by the object with the aid of a detector; and determining the geometric surface profile from the detected light.

The methods described in the prior art have the disadvantage of being limited with respect to the materials employed, which must have certain properties, such as particle size or composition, in order to compensate for the shrinkage from sintering. Thus, because of the different material properties in terms of shrinkage, for example, in a component that is different between layers, or gradually, or even in partial regions of the shape, all components are always adjusted to a uniform sintering behavior at a desired preselected temperature, in order that as homogeneous as possible a shrinkage can be obtained for the respective direction in space for the complete component over its length, height or width, and the distortion of the component can be eliminated.

Therefore, it has been the object of the present invention to provide a process that has no limitation in terms of the materials employed and their combination, and dispenses with a particular manipulation of the materials.

Surprisingly, it has been found that this object is achieved by determining the distortion from sintering already before a blank is processed, and the processing is performed in accordance with the determined distortion from sintering.

Therefore, the present invention relates to a process for preparing a shaped product, comprising the following steps:

a) providing a blank, said blank having an inhomogeneous sintering behavior;
b) processing the blank from step a) to obtain a shaped product; and
c) sintering the shaped product from step b) to a desired final density;
characterized in that the shrinkage of the blank is determined before the blank is processed, and the processing is performed in accordance with the spatially resolved scale-up factors obtained during the determination.

The advantage of the process according to the invention resides in the fact that the temperature range applied and thus the densities can be set rather variably, especially in multilayer systems whose individual layers have different sintering behaviors. Therefore, the only requirement in the choice of temperature for sintering is the mechanical processability of the blanks, such as millability and grindability, for the faultless preparation of the desired geometry.

A “blank having an inhomogeneous sintering behavior” within the meaning of the present invention means a blank that has different sintering behaviors in different parts thereof. This can be caused, for example, by constituting the blank from different components that have respectively different sintering behaviors. Such an inhomogeneous sintering behavior may also occur in blanks that consist of only one component, but in which the properties differ in different parts thereof, for example, from the blank's having a density gradient. Accordingly, a process is preferred in which the blank has at least two components with different sintering behaviors, or one component with an inhomogeneous sintering behavior.

In a particularly preferred embodiment, the blank comprises several components with different sintering behaviors, wherein the components are differently arranged between layers or gradually or in partial regions of the shape.

The processing of the blank is effected in consideration of the shrinkage occurring during the sintering. Thus, according to the invention, the shrinkage caused by sintering is determined in a spatially resolved way before the processing. “Shrinkage” within the meaning of the present invention means the change of length, change of width and change of height of the shaped product as caused by sintering. The extent of shrinkage depends, among other things, on the chemical composition, particle size, heating rate during the sintering process, pressed density, density distribution in the blank, and the sintering rate. The inhomogeneous sintering behavior of the blank results in the fact that anisotropic shrinkage occurs within the blank, which may lead, for example, to a geometric distortion of the blank.

The process according to the invention is characterized in that the individual shrinkage of the shaped product is determined before it is processed, and the processing is performed in consideration of the inhomogeneous shrinkage behavior, optionally using form factors. In order to obtain a shaped product that is particularly true to shape, an exact determination of shrinkage is indispensable. Therefore, the respective shrinkage of the shaped product is determined in a spatially resolved way by the process according to the invention. The determination is effected by obtaining spatially resolved scale-up factors in all three direction of space for each coordinate point of the shaped product. The process according to the invention offers the advantage that the spatially resolved scale-up factors can be adjusted individually for each coordinate point and in each direction of space. Thus, for example, the scale-up factor in x direction may be different from that in y direction. Therefore, an embodiment is preferred in which the spatially resolved scale-up factors are independent of one another. Preferably, more than one scale-up factor is employed during the processing.

In contrast to the processes described in the prior art, the process according to the invention is not limited with respect to the materials that can be used. Therefore, an embodiment of the process is preferred in which the blank includes oxidic and/or non-oxidic raw materials. The mentioned raw materials are preferably ceramic and metallic materials. The oxidic raw materials are preferably selected from the group consisting of zirconium oxide, silicates, aluminum oxide, beryllium oxide, titanium oxide, aluminum titanate, barium titanate, and mixtures thereof. The non-oxidic raw materials may be selected, for example, from the group consisting of silicon carbide, boron nitride, boron carbide, silicon nitride, aluminum nitride, molybdenum silicide, tungsten carbide, and mixtures thereof.

In a further preferred embodiment, the oxidic raw materials are selected from the group consisting of zirconium oxide, silicates, and aluminum oxide.

In a particularly preferred embodiment, the blank includes one or more materials selected from the group consisting of zirconium oxide (ZrO₂), aluminum oxide (Al₂O₃), silicon carbide (SiC), silicon nitride (Si₃N₄), silicates, and mixtures thereof.

In a preferred embodiment, the oxidic raw materials can be together with other oxides. Such other oxides are preferably stabilizing oxides. Thus, in a particularly preferred embodiment, the oxidic raw material is yttrium-stabilized zirconium oxide. In a particularly preferred embodiment, the content of the other oxide is from 0.01% by weight to 20% by weight, preferably from 0.1% to 15% by weight, more preferably from 0.5% to 10% by weight, respectively based on the total weight of the oxidic raw material.

In an alternatively preferred embodiment, the blank includes at least one metallic material, preferably a metallic alloy.

In many applications, it has proven advantageous to add additives to the blank, for example, in order to achieve certain properties. Therefore, an embodiment is preferred in which the blank contains further additives. Such additives are preferably colorants and/or coloring oxides. Particularly preferred are colorants and/or coloring oxides selected from the group consisting of oxides of yttrium, lanthanum, vanadium, terbium, titanium, manganese, magnesium, erbium, iron, copper, chromium, cobalt, nickel, selenium, silver, indium, gold, and rare-earth metals, among the latter especially neodymium, praseodymium, samarium and europium. The amount of colorants and/or coloring oxides depends on the desired final result and may be, for example, within a range of a few ppm to some percent by weight. Thus, the proportion of colorant and/or coloring oxide may be, for example, from 1 ppm to 500 ppm, preferably from 5 ppm to 300 ppm, the ppm being parts by weight. In contrast, in other preferred embodiments, the proportion may be from 0.1% by weight to 5.0% by weight, preferably from 0.2 to 3.0% by weight, respectively based on the total weight of the blank.

Further, other agents may be added to the raw materials, such as binders, pressing additives and waxes. Usually, such agents are removed after the blank has been pressed, preferably by a thermal treatment of the pressed blank.

Usually, the blank provided in step a) of the process according to the invention is a pressed material. In some applications, however, it may be of advantage to presinter the blank in order to provide it with the strength necessary, for example, for machine processing. Therefore, an embodiment is preferred in which the blank provided in step a) is a presintered blank. A “presintered blank” within the meaning of the present invention means a blank that has already been subjected to a sintering treatment, but without reaching the desired final density.

The precise imaging of predefined data is of special importance, in particular, when the products are components to be assembled into a composite. An example of such a composite is human teeth, in addition to the usual technical applications. As in other fields, there is a difficulty in that a dental restoration must have a high accuracy of fit to be included in the existing dental scheme. In such a case, the process according to the invention is particularly suitable, because it allows for the production of shaped products having a high accuracy of shape and fit, also from ceramic materials, as is usual in the field of dental restorations. Therefore, in a particular embodiment of the process according to the invention, the shaped product obtained is a dental restoration. The dental restoration is preferably selected from the group consisting of tooth restorations, bridge restorations, implants and implant abutments.

According to step b) of the process according to the invention, the blank is processed to obtain a shaped product. The processing is preferably effected by a CAD/CAM method. Processing by a CAD/CAM method enables a true representation of the established geometric design of the shaped product to be obtained, in which the desired shrinkage has been taken into account, in particular.

After such processing, the shaped product can be subjected to further process steps. For example, the shaped product can be colored, in which the coloring substances can be applied by the usual methods, such as painting or immersing into corresponding solutions.

According to step c) of the process according to the invention, the shaped product obtained in step b) is sintered to a desired final density. The final density of the shaped product depends on the intended use. In some fields of application, it may be advantageous to provide the shaped product with as high as possible a density that is close to the maximum theoretically possible density.

Alternatively or additionally, a coating may be applied to the thus sintered shaped product. These additional process steps, which mainly pertain to the aesthetic design and surface treatment of the blank, are of importance, in particular, if the shaped product is a dental restoration whose aesthetic properties are to be adapted to those of a patient's existing teeth.

In other fields of application, it may be advantageous for the shaped product to have some porosity. This is the case, for example, if the shaped product is to be subjected to further treatment steps. Thus, for example, it is possible to introduce filling materials into the pores remaining in the shaped product. This kind of treatment can be found, for example, in the preparation of electronic components, but has also entered the field of dental restorations.

Especially in the field of dental engineering, it is important that production methods for dental restorations can be performed easily and take little time, so that the patients can be provided with the appropriate dental restoration, if possible, on the spot and in only one treatment session. The process according to the invention offers the advantage that the processing of the blank as well as the sintering of the shaped product to the desired final density can be performed on the spot, for example, at the dentist's. Because of the previously established and provided spatially resolved scale-up factors, the sintering process can be performed in such a way that different materials can be contained in the blank, while the blank corresponds to the desired final shape after the dense sintering, despite the inhomogeneous sintering behavior. Therefore, in a preferred embodiment, the process according to the invention further comprises the provision of a data set that includes the spatially resolved scale-up factors obtained during the determination of the shrinkage of the blank. In a further preferred embodiment, the process according to the invention comprises the following steps:

a) providing a blank, said blank having an inhomogeneous sintering behavior;
b) determining the shrinkage of the blank to obtain a set of spatially resolved scale-up factors;
c) providing the set of spatially resolved scale-up factors obtained during the determination of the shrinkage of the blank;
d) processing the blank to obtain a shaped product; and
e) sintering the shaped product to a desired final density;
wherein the processing is performed in accordance with the spatially resolved scale-up factors obtained during the determination of the shrinkage.

The determination of the shrinkage of the blank can be effected at any time before the processing of the blank.

In a preferred embodiment, the process according to the invention further comprises the step of checking the established set of spatially resolved scale-up factors. Such checking is preferably effected by applying the set of spatially resolved scale-up factors determined in step b) of the process according to the invention to another blank to obtain a shaped product, followed by sintering this shaped product to the desired final density. In this way, the quality of the established set of spatially resolved scale-up factors is ensured in order to guarantee a comfortable handling and an accurately fitting final result.

The process according to the invention allows for the provision of a blank and of a set of spatially resolved scale-up factors determined in accordance with the shrinkage of the blank. Surprisingly, it has been found that the provision of a set of spatially resolved scale-up factors that are individually adapted to the blank enables a simple and comfortable production of a dimensionally accurate shaped product. Therefore, the present invention further relates to a kit, comprising:

i) a blank; and
ii) a set of spatially resolved scale-up factors,
wherein said set of spatially resolved scale-up factors is obtained by determining the shrinkage of the blank.

Said blank is preferably a blank as described above. More preferably, the blank includes different components with different sintering behaviors, wherein the components are not homogeneously arranged in the blank.

The present invention further relates to a kit, comprising a blank and an information carrier, in which said information carrier contains a set of spatially resolved scale-up factors obtained by the determination of the shrinkage of the blank. Said blank is preferably a blank as described above. More preferably, the blank includes different components with different sintering behaviors, wherein the components are preferably arranged differently between layers or gradually or in partial regions of the shape. In a particularly preferred embodiment, the blank and the information carrier are integrally formed. More preferably, the blank serves as an information carrier. In this way, a simple and comfortable handling is ensured.

The present invention further relates to a shaped product having an inhomogeneous sintering behavior, said shaped product having a shape adapted to its sintering behavior. An inhomogeneous sintering behavior may occur, for example, if the shaped product is composed of more than one component, in which the components show different sintering behaviors. In other cases, an inhomogeneous sintering behavior exists if different regions of the shaped product have different properties. This may be the case, for example, if the shaped product has a density gradient or was inhomogeneously pressed.

Preferably, the shaped product according to the invention is a shaped product having at least two components with different sintering behaviors, or one component with an inhomogeneous sintering behavior, in which the shape of the shaped product is adapted to the sintering behavior of the individual components.

Generally, the sintering leads to geometric changes, which are particularly pronounced if the shaped product has an inhomogeneous sintering behavior. In a preferred embodiment, the shaped product according to the invention is characterized in that it is brought into a desired shape by sintering. This can be achieved, inter alia, by taking the distortion due to sintering to be expected into account when the shaped product is being shaped.

The shape of the shaped product that takes the shrinkage into account is predefined by spatially resolved scale-up factors.

The material of the shaped product can be selected as a function of the intended use. In a preferred embodiment, the shaped product includes oxidic and/or non-oxidic raw materials. The mentioned raw materials are preferably ceramic and metallic materials. The oxidic raw materials are preferably selected from the group consisting of zirconium oxide, silicates, aluminum oxide, beryllium oxide, titanium oxide, aluminum titanate, barium titanate, and mixtures thereof. The non-oxidic raw materials may be selected, for example, from the group consisting of silicon carbide, boron nitride, boron carbide, silicon nitride, aluminum nitride, molybdenum silicide, tungsten carbide, and mixtures thereof.

In a particularly preferred embodiment, the shaped product includes one or more materials selected from the group consisting of zirconium oxide (ZrO₂), aluminum oxide (Al₂O₃), silicon carbide (SiC), silicon nitride (Si₃N₄), silicates, and mixtures thereof.

In a preferred embodiment, the oxidic raw materials can be together with other oxides. Such other oxides are preferably stabilizing oxides. Thus, in a particularly preferred embodiment, the oxidic raw material is yttrium-stabilized zirconium oxide. In a particularly preferred embodiment, the content of the other oxide is from 0.01% by weight to 20% by weight, preferably from 0.1% to 15% by weight, more preferably from 0.5% to 10% by weight, respectively based on the total weight of the oxidic raw material. In an alternatively preferred embodiment, the blank includes at least one metallic material, preferably a metallic alloy.

In a further preferred embodiment, the shaped product may contain additives. For example, such additives can be used to provide the shaped product with particular properties, especially visually. Thus, the additives are preferably colorants and/or glass-coloring oxides. Particularly preferred are colorants and/or glass-coloring oxides selected from the group consisting of oxides of yttrium, lanthanum, vanadium, terbium, titanium, manganese, magnesium, erbium, iron, copper, chromium, cobalt, nickel, selenium, silver, indium, gold, and rare-earth metals, among the latter especially neodymium, praseodymium, samarium and europium.

Furthermore, additives can be used to influence the mechanical properties of the shaped product, for example. In particular, in the field of dental restorations, in which ceramic materials are mainly used, there is the problem that the shaped restorations become distorted during the sintering, which is even more pronounced in multicomponent systems. The shaped product according to the invention is characterized in that its shape is adapted to its sintering behavior, and that it obtains its desired shape by sintering. Accordingly, it is particularly suitable for use as a dental restoration. This is why the shaped product according to the invention is preferably a dental restoration. Said dental restoration is preferably selected from the group consisting of tooth restorations, bridge restorations, implants and implant abutments.

In a particularly preferred embodiment, the shaped product is obtainable by the process according to the invention.

The invention further relates to a shaped product obtainable by the process according to the invention.

The shaped product according to the invention is suitable, in particular, for use in the field of dental restorations. Therefore, the present invention further relates to the use of the shaped product according to the invention for preparing a dental restoration.

The present invention shall be explained in more detail by means of the following Examples and Figures, which are not to be understood as limiting the idea of the invention.

### EXAMPLES

### 1. Blank Consisting of One Component with an Inhomogeneous Shrinkage Behavior

### Example 1 (Comparison)

In a first step, yttria-stabilized zirconia powder was pressed uniaxially from both sides to form a cuboid body. In this process, a density gradient forms within the body because of friction between the particles and the friction towards the pressing die wall in the pressing pressures necessary for such material, despite an optimized binder system and optimized flowability and slidability of the powder granules. The lowest density is found along the press-neutral zone. In this region, the lowest compaction of the powder granules occurs.

The pressed body was subjected to a thermal treatment at temperatures of up to 700° C. in order to remove organic additives. In a second thermal treatment, the body was presintered to from 50 to 60% of its maximum theoretical density at temperatures within a range of from 1000° C. to 1200° C.

A cuboid was milled from the presintered body. Its outer dimensions result from the sought intended geometry, i.e., the shrinkage occurring during the dense sintering was taken into account by enlarging the outer dimensions of the intended geometry using a uniform scale-up factor.

The milled-out cuboid was sintered to the desired final density at temperatures of from 1300° C. to 1600° C. The geometry of the sintered body was scanned and acquired using a profilometer. The dense-sintered body exhibits a deviation from the intended geometry. This is caused by the density gradient occurring in the body, which is maintained during the presintering of the blank, and leads to an inhomogeneous sintering behavior. Therefore, the sintered body shows a significant deviation from the intended geometry in the region of the press-neutral zone.

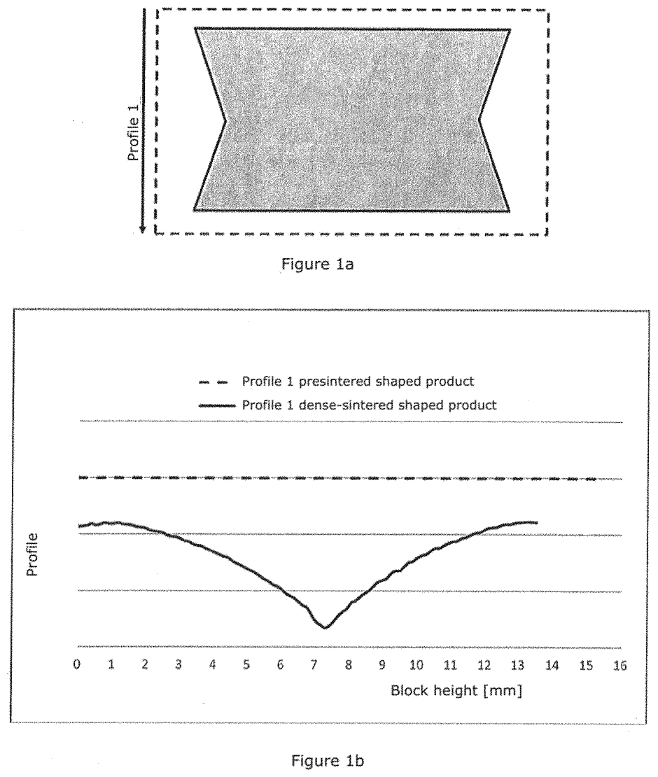

FIG. 1a shows the schematic representation of the milled-out body (bright) and of the dense-sintered body (dark), in which the deviation from the intended geometry is clearly seen.

FIG. 1b represents the profile measurement of the milled presintered body and of the dense-sintered body along the plane indicated in FIG. 1a. Here too, the significant deviation of the dense-sintered body from the sought cuboid intended geometry can be seen.

### Example 2 (According to the Invention)

By analogy with Example 1, a presintered body was prepared from yttria-stabilized zirconia. From the presintered body, a cuboid blank was milled whose outer dimensions result from the intended geometry of the dense-sintered body. In contrast to Comparative Example 1, no uniform scale-up factor was used to consider the shrinkage occurring during the sintering. Rather, the inhomogeneous sintering behavior of the body was taken into account by scaling up the dimensions of the intended geometry in a spatially resolved manner in accordance with the density distribution. For this purpose, each coordinate point of the intended geometry was assigned its own scale-up factor, resolved in x, y, z coordinates, in order to obtain the geometry to be milled out.

By analogy with Example 1, the milled body was sintered to the desired final density, which is the same as that of the body described in Example 1, at temperatures within a range of from 1300° C. to 1600° C.

The dense-sintered body was scanned using a profilometer, in order to determine the outer dimensions.

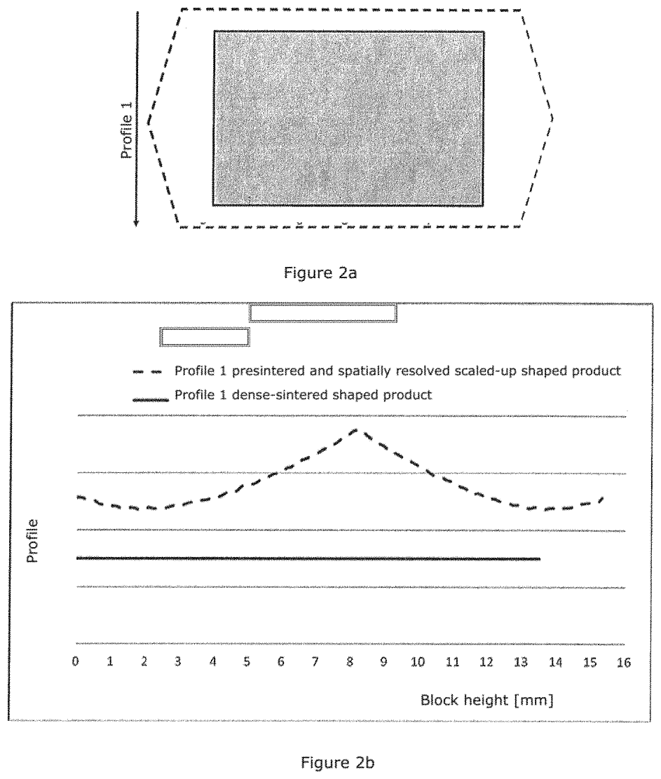

FIG. 2a shows the schematic representation of the presintered milled body (bright) and of the dense-sintered body (dark), in which it is clearly seen that the dense-sintered body corresponds to the intended geometry.

FIG. 2b represents the profile measurement of the milled-out and of the dense-sintered body along the plane indicated in FIG. 2a. In contrast to Comparative Example 1, the dense-sintered body does not show any deviations from the intended geometry.

### 2. Blank Consisting of Four Layers with Different Compositions

### Example 3 (Comparison)

Different yttria-stabilized zirconia powders were filled layer by layer into a press die, in which the powders respectively contained different additives in the form of iron oxide, cobalt oxide and erbium oxide. The layers were pressed uniaxially from both sides to form a cuboid blank. Because of the different compositions of the layers, different sintering behaviors are respectively obtained.

The pressed body was subjected to a thermal treatment at temperatures of up to 700° C. in order to remove organic additives. In a second thermal treatment, the body was presintered to from 50 to 60% of its maximum theoretical density at temperatures within a range of from 1000° C. to 1200° C.

A cuboid was milled from the presintered body. Its outer dimensions result from the sought intended geometry, i.e., the shrinkage occurring during the dense sintering was taken into account by enlarging the outer dimensions of the intended geometry using a uniform scale-up factor.

The milled-out cuboid was sintered to the desired final density at temperatures of from 1300° C. to 1600° C. The geometry of the sintered body was scanned and acquired using a profilometer. The dense-sintered body exhibits a deviation from the intended geometry. This is caused by the different sintering behaviors of the layers. The dense-sintered body clearly exhibits warping.

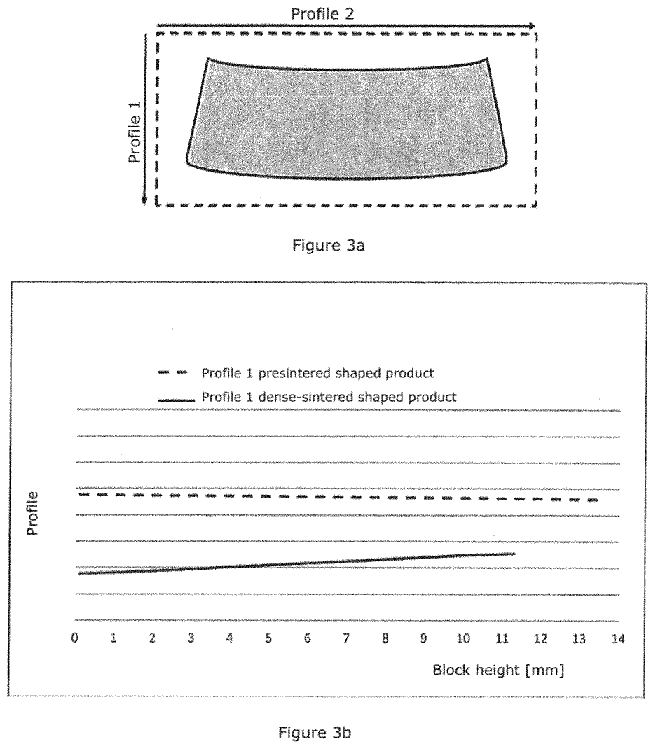

FIG. 3a shows the schematic representation of the presintered milled body (bright) and of the dense-sintered body (dark), in which the deviation from the intended geometry is clearly seen.

FIGS. 3b and 3c represent the profile measurement of the presintered milled body and of the dense-sintered body along the planes indicated in FIG. 3a. Here too, the significant deviation of the dense-sintered body from the sought cuboid intended geometry can be seen.

### Example 4 (According to the Invention)

By analogy with Example 3, a multi-layered presintered body was prepared from yttria-stabilized zirconia. From the presintered body, a cuboid blank was milled whose outer dimensions result from the intended geometry of the dense-sintered body. In contrast to Comparative Example 3, no uniform scale-up factor was used to consider the shrinkage occurring during the sintering. Rather, the inhomogeneous sintering behavior of the body was taken into account by scaling up the dimensions of the intended geometry in a spatially resolved manner. For this purpose, each coordinate point of the intended geometry was assigned its own scale-up factor, resolved in x, y, z coordinates, in order to obtain the geometry to be milled out.

By analogy with Example 3, the milled body was sintered to the desired final density, which is the same as that of the body described in Example 3, at temperatures within a range of from 1300° C. to 1600° C.

The dense-sintered body was scanned using a profilometer, in order to determine the outer dimensions.

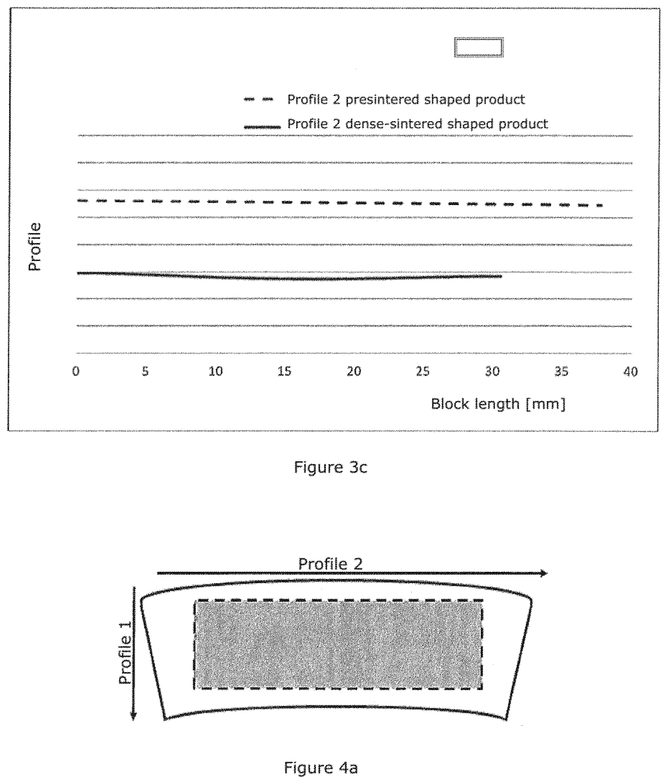

FIG. 4a shows the schematic representation of the presintered milled body (bright) and of the dense-sintered body (dark), in which it is clearly seen that the dense-sintered body corresponds to the intended geometry.

FIGS. 4b and 4c represent the profile measurement of the presintered milled body and of the dense-sintered body along the planes indicated in FIG. 4a. In contrast to Comparative Example 3, the dense-sintered body does not show any deviations from the intended geometry. The lateral faces of the cuboid are straight and plano-parallel in accordance with the intended geometry.

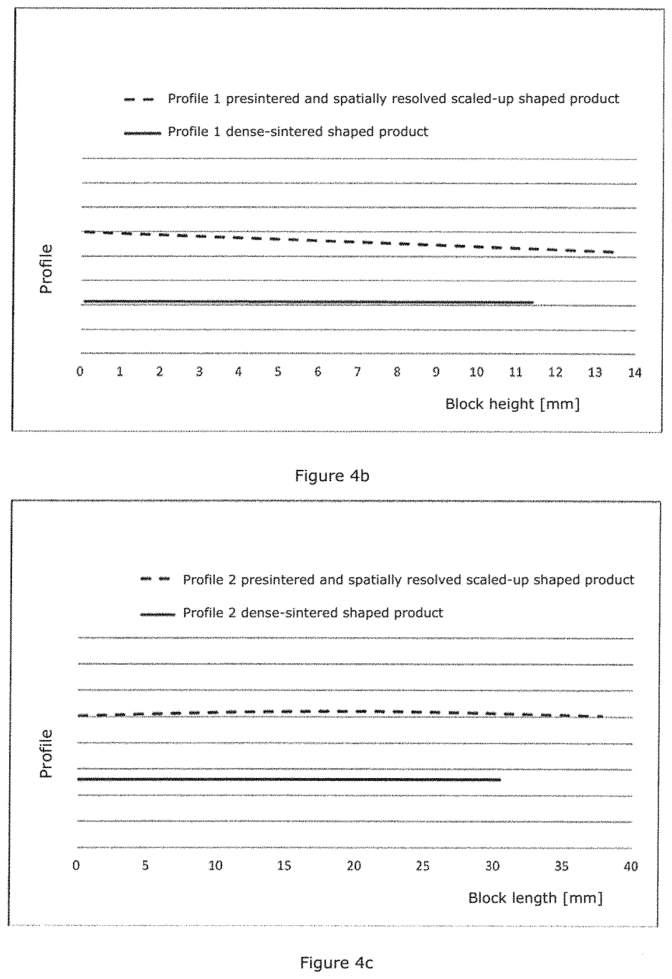

FIG. 5 demonstrates in an exemplary way the use of the spatially resolved scale-up factors in the determination of the distortion due to sintering. The process according to the invention allows for an individual adaptation of the scale-up factors. Thus, for example, the scale-up factor VGF2 at the lower plane 4 can be selected smaller than the scale-up factor VGF1 at the corner of plane 1 in each direction of space.

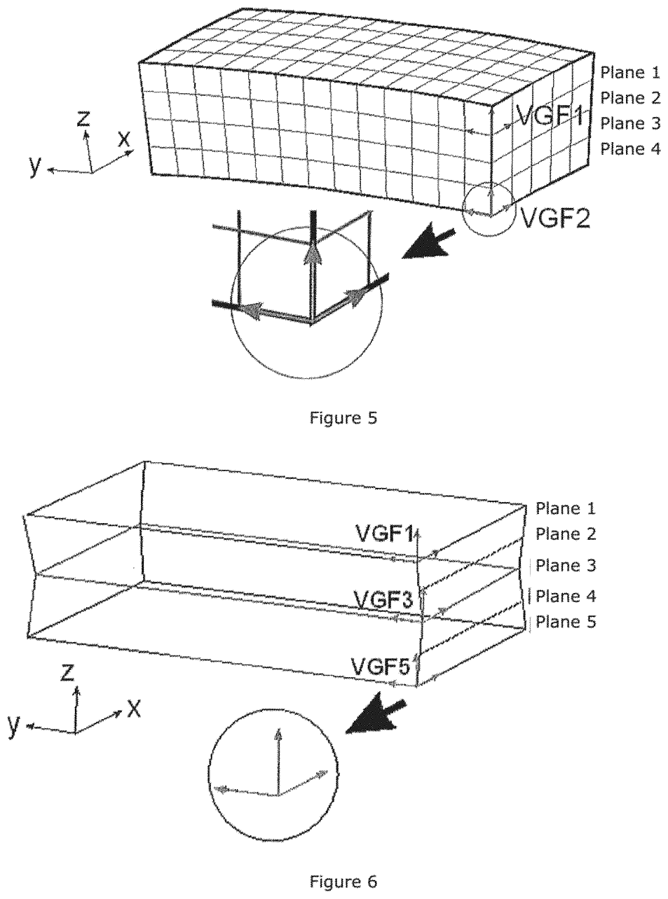

FIG. 6 also shows in an exemplary way a multi-layered shaped product whose planes exhibit different sintering behaviors. Here too, optimum adaptation can be achieved by selecting the scale-up factors that are individually adapted accordingly. Thus, in the present Example:
VGF (x, E1; E5)<VGF (x, E3)
VGF (y, E1; E5)<VGF (y, E3)
VGF (z, E1; E5)<=>VGF (z, E3)

As the provided Examples and FIGS. 5 and 6 illustrate, the process according to the invention allows for the dimensionally accurate production of shape-structured inhomogeneous shaped products despite the different sintering behaviors of the individual partial regions of the shaped product, by using spatially resolved scale-up factors.

1. A process for preparing a shaped product, comprising the following steps:
a) providing a blank, said blank having an inhomogeneous sintering behavior;
b) processing the blank from step a) to obtain a shaped product; and
c) sintering the shaped product from step b) to a desired final density;
characterized in that the shrinkage of the blank is determined before the blank is processed, and the processing is performed in accordance with the spatially resolved scale-up factors obtained during the determination.

2. The process according to claim 1, characterized in that the blank has at least two components with different sintering behaviors, or one component with an inhomogeneous sintering behavior.

3. The process according to claim 1, characterized in that the blank comprises several components with different sintering behaviors, wherein the components are differently arranged between layers or gradually or in partial regions of the shape.

4. The process according to claim 1, characterized in that the blank comprises one or more materials selected from silicate raw materials or oxidic raw materials or non-oxidic raw materials.

5. The process according to claim 1, characterized in that the blank comprises at least one ceramic material, preferably selected from the group consisting of zirconium oxide (ZrO₂), aluminum oxide (Al₂O₃), silicon carbide (SiC), silicon nitride (Si₃N₄), silicates, and mixtures thereof.

6. The process according to claim 1, characterized in that the shaped product is a dental restoration.

7. The process according to claim 1, characterized in that the blank provided in step a) is a presintered blank.

8. A kit, comprising:
i) a blank; and
ii) a set of spatially resolved scale-up factors,
wherein said set of spatially resolved scale-up factors is obtained by determining the shrinkage of the blank.

9. A shaped product, characterized in that said shaped product has an inhomogeneous sintering behavior, and has a shape adapted to its sintering behavior.

10. The shaped product according to claim 9, characterized in that said shaped product is brought into a desired shape by sintering.

11. The shaped product according to claim 9, characterized in that the shape of the shaped product is predefined by spatially resolved scale-up factors.

12. The shaped product according to claim 9, characterized in that the shaped product comprises several components with different sintering behaviors, wherein the components are differently arranged between layers or gradually or in partial regions of the shape.

13. The shaped product according to claim 1, characterized in that the shaped product comprises one or more raw materials selected from silicate raw materials or oxidic raw materials or non-oxidic raw materials.

14. The shaped product according to claim 1, characterized in that the shaped product is a dental restoration.

15. The shaped product according to claim 14, characterized in that said dental restoration is selected from the group consisting of tooth restorations, bridge restorations, implants and implant abutments.

16. A shaped product obtainable by a process according to claim 1.

17. (canceled)
